(19) United States
(12) Patent Application Publication
(10) Pub. No.: US 2025/0168799 A1
(43) Pub. Date: May 22, 2025

(54) METHOD AND APPARATUS FOR OPERATING DYNAMIC MANAGEMENT OF CONTROL PLANE SERVICES

(71) Applicant: SAMSUNG ELECTRONICS CO., LTD., Suwon-si (KR)

(72) Inventors: Jinho CHOI, Suwon-si (KR); Youngdae KOO, Suwon-si (KR); Jaheon GU, Suwon-si (KR); Dongmyung KIM, Suwon-si (KR); Jeonga LIM, Suwon-si (KR); Sunwoo CHO, Suwon-si (KR); Jiyoung CHA, Suwon-si (KR)

(21) Appl. No.: 18/951,503

(22) Filed: Nov. 18, 2024

(30) Foreign Application Priority Data
Nov. 20, 2023 (KR) 10-2023-0160237

(51) Int. Cl. H04W 60/00; H04W 16/14; H04W 48/18; H04W 76/10

(52) U.S. Cl. CPC H04W 60/00; H04W 16/14; H04W 48/18; H04W 76/10

(57) ABSTRACT

The present disclosure relates to a 5G communication system or a 6G communication system for supporting higher data rates beyond a 4G communication system such as long term evolution (LTE). According to an embodiment of the present disclosure, a method of operating a user defined service (UDS) performed by a first network entity in a wireless communication system may be disclosed, the method comprising: receiving, from an application function (AF), a UDS registration procedure request message including information on a UDS network function (NF) and information on a UE container; transmitting, to operation administration maintenance (OAM), a request message for UDS deployment including information on the UDS NF; and transmitting, to a UDS agent in user equipment (UE), a UE container deployment request message including information on the UE container.

### CROSS REFERENCE TO RELATED APPLICATION

The present application claims priority to Korean Patent Application No. 10-2023-0160237, filed on Nov. 20, 2023, the entire contents of which is incorporated herein for all purposes by this reference in its entirety.

### BACKGROUND

### 1. Field

The present disclosure relates to, as a technology for the control plane of a wireless communication system, a method and apparatus for dynamically managing network services by introducing a new network device (network function) into a core network of a wireless communication system and introducing a new logical device into user equipment (UE).

### 2. Description of the Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

A control plane of a conventional wireless communication system is configured of an access stratum (AS) sublayer, which uses an AS protocol, and a non-access stratum (NAS) sublayer, which uses an NAS protocol. The AS protocol is used for exchanging control messages between user equipment and a base station, while the NAS protocol is used for exchanging control signals between user equipment and core network devices. The NAS sublayer is further divided into a NAS mobility management (NAS-MM) service and other NAS services. The NAS-MM service is used for exchanging control messages between user equipment and an access and mobility management function (AMF), while other NAS services can exchange control messages only through the NAS-MM service. This protocol configuration and the relationships between layers are specialized information for wireless communication systems, standardized by 3GPP, and typically implemented in chipsets on the basis of the corresponding standards.

With the advancement and widespread adoption of network function virtualization and cloud technologies, the core network of the 5G wireless communication system has introduced a service-based architecture (SBA). Within this architecture, each network function (NF) is defined as software that provides one or more services. This service-based architecture (SBA) aims to evolve the core network to facilitate modifications and deployment. In addition, the system was intended to support a service mesh form to facilitate the introduction of new network functions and to support a structure advantageous for mutual service discovery and utilization.

As described above, the core network of the 5G wireless communication system has sought to evolve to enable flexible modification, deployment, and introduction of services. However, these evolutionary efforts were limited to the core network portion within the control plane of the 5G system. Accordingly, when a network function for a new service is newly defined within the core network, connections with other network devices may be established through the common service-based interface (SBI) adopted by the conventional system, allowing mutual service to be provided. However, in order for the service to exchange control messages with user equipment (UE), the new service needs be applied on top of the NAS mobility management (NAS-MM) service of the user equipment. Additionally, both the NAS-MM layers of the user equipment and the network needed to be updated to deliver the service's messages. In order to perform this update, there was a drawback in that a long lead time was required.

### SUMMARY

The present disclosure aims to enable a system to minimize a lead time associated with the introduction of new services within the network by flexibly configuring a control plane connection of UE to configure a logical device in a core network that can dynamically manage services when the provision of a new service is required within the network.

According to an embodiment of the present disclosure, provided to solve the aforementioned problems, an operation method of a user defined service (UDS) performed by a first network entity within a wireless communication system is disclosed. The method may include: receiving, from an application function (AF), a UDS registration procedure request message including information on a UDS network function (NF) and information on a UE container; transmitting, to operation administration maintenance (OAM), a request message for UDS deployment including information on the UDS NF; and transmitting, to a UDS agent in user equipment (UE), a UE container deployment request message including information on the UE container.

According to an embodiment of the present disclosure, the method may further include transmitting, to a second network entity, a routing configuration request message for the UDS.

According to an embodiment of the present disclosure, the method may further include allocating an extended protocol discriminator (EPD) for the UDS when a protocol used by the UDS is a non-access stratum (NAS), in which the routing configuration request message may include address information on the UDS NF mapped to the EPD.

According to an embodiment of the present disclosure, when the protocol used by the UDS is not a NAS, the routing configuration request message may include a signaling radio bearer (SRB) allocation request for IP packets.

According to an embodiment of the present disclosure, the method may further include: receiving, from the UDS agent, handover event-related information on the user equipment; determining a change of a NAS anchor on the basis of information on the NAS anchor that delivers the handover event-related information; and transmitting information on the change of the NAS anchor to the UDS NF when it is determined that the NAS anchor has changed.

According to another embodiment of the present disclosure, provided to solve the aforementioned problems, a method performed by a user defined service agent (UDS agent) within user equipment operating in a wireless communication system may be disclosed. The method may include: receiving, from a first network entity, a UE container deployment request message including information on a UE container related to the UDS; installing the UE container in the user equipment; and configuring a message delivery path for the UE container.

The method may further include: receiving, from an access and mobility management function (AMF), an extended protocol discriminator (EPD); and transmitting a connection request message including the EPD to the first network.

The method may further include requesting an access stratum (AS) layer in the user equipment to configure a service access point (SAP) corresponding to the UDS when a protocol used by the UDS is a non-access stratum (NAS).

The method may further include requesting an access stratum (AS) layer in the user equipment to configure a signaling radio bearer (SRB) on the basis of SRB information received from the first network entity when a protocol used by the UDS is not a non-access stratum (NAS).

The method may further include: receiving information on occurrence of a handover event from a modem of the user equipment; and transmitting handover event-related information to the first network entity.

According to another embodiment of the present disclosure, a first network entity operating a UDS within a wireless communication system is disclosed. The first network entity may include: a transceiver; and a controller, in which the controller may be configured to receive, from an application function (AF), a UDS registration procedure request message including information on a UDS network function (NF) and information on a UE container, transmit, to operation administration maintenance (OAM), a request message for UDS deployment including information on the UDS NF, and transmit, to a UDS agent in user equipment (UE), a UE container deployment request message including information on the UE container.

According to another embodiment of the present disclosure, a UDS agent within a user equipment operating in a wireless communication system is disclosed. The UDS agent may include: a transceiver and a controller, in which the controller may be configured to receive, from a first network entity, a UE container deployment request message including information on a UE container related to a UDS, install the UE container in the user equipment, and configure the message delivery path for the UE container.

According to various embodiments of the present disclosure, when a new function is added to the system or changes to the transmitted information or message format are required due to an upgrade of a specific function, the system can flexibly respond by network devices (network functions) in the control plane and new logical devices within the user equipment that are newly introduced.

According to various embodiments of the present disclosure, the introduction of various services that can effectively utilize the functions of devices with various form factors and capabilities can be facilitated.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a control plane connection structure in a wireless communication system according to an embodiment of the present disclosure;

FIG. 2 illustrates a user equipment in a wireless communication system according to an embodiment of the present disclosure;

FIG. 3 illustrates a wireless communication system according to an embodiment of the present disclosure;

FIG. 4 illustrates a wireless communication system according to an embodiment of the present disclosure;

FIG. 5 illustrates a flowchart of a method for performing a UDS registration procedure according to an embodiment of the present disclosure;

FIG. 6 illustrates a flowchart of a method for deploying, by UDSM, a UDS on a network side an embodiment of the present disclosure;

FIG. 7 illustrates a flowchart of a method for removing, by the UDSM, the UDS on a network an embodiment of the present disclosure;

FIG. 8 illustrates a flowchart of a method for configuring, by the UDSM, a message delivery path for each UDS within the network an embodiment of the present disclosure;

FIG. 9 illustrates a flowchart of a method for modifying, by the UDSM, the message delivery path configured for each UDS an embodiment of the present disclosure;

FIG. 10 illustrates a flowchart of a method for deploying a UE container according to an embodiment of the present disclosure;

FIG. 11 illustrates a flowchart of a method for removing a UE container according to an embodiment of the present disclosure;

FIG. 12 illustrates a flowchart of a connection procedure between a UDS agent and UDSM according to an embodiment of the present disclosure;

FIG. 13 illustrates a connection structure of logical devices within user equipment according to an embodiment of the present disclosure;

FIG. 14 illustrates a flowchart of a method for deploying, by a UDS agent, a UE container and performs initial configuration according to an embodiment of the present disclosure;

FIG. 15 illustrates a flowchart of a method for updating UDS delivery information according to an embodiment of the present disclosure;

FIG. 16 illustrates a flowchart of a method for a procedure of UDS deployment and message exchange an embodiment of the present disclosure;

FIG. 17 illustrates a structure of a terminal according to an embodiment of the present disclosure; and

FIG. 18 illustrates a structure of a network entity according to an embodiment of the present disclosure.

### DETAILED DESCRIPTION

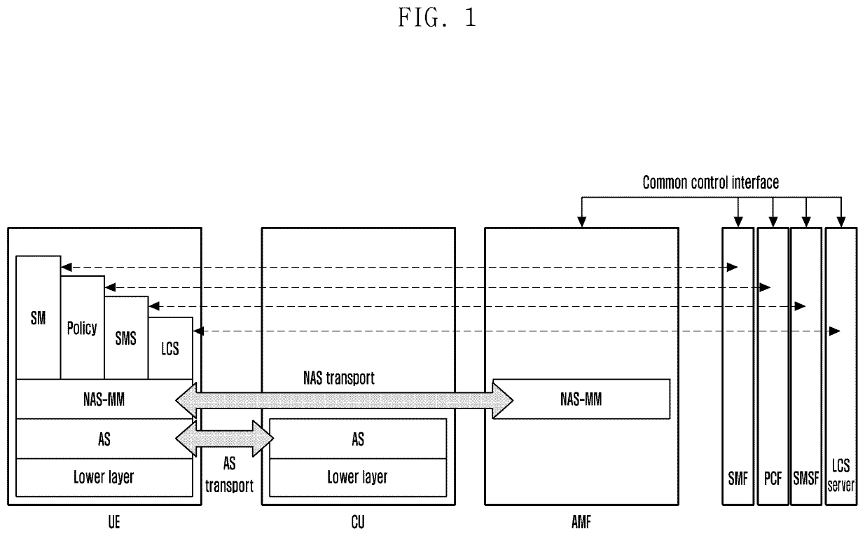

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the present disclosure will be described with reference to the accompanying drawings. In this case, it should be noted that the same constituent elements will be designated by the same reference numerals in the accompanying drawings. In addition, detailed descriptions of publicly-known functions and configurations, which may obscure the subject matter of the present disclosure, will be omitted.

When describing the embodiments in the present disclosure, a description of technical contents, which are well known in the technical field to which the present disclosure pertains but are not directly related to the present disclosure, will be omitted. This is to more clearly describe the subject matter of the present disclosure without obscuring the subject matter by omitting any unnecessary description.

Similarly, in the accompanying drawings, some constituent elements are illustrated in an exaggerated or schematic form or are omitted. In addition, a size of each constituent element does not entirely reflect an actual size. Like reference numerals designate like or corresponding constituent elements in the drawings.

Advantages and features of the present disclosure and methods of achieving the advantages and features will be clear with reference to exemplary embodiments described in detail below together with the accompanying drawings. However, the present disclosure is not limited to the exemplary embodiments disclosed herein but will be implemented in various forms. The exemplary embodiments of the present disclosure are provided so that the present disclosure is completely disclosed, and a person with ordinary skill in the art can fully understand the scope of the present disclosure. The present disclosure will be defined only by the scope of the appended claims. Throughout the specification, the same reference numerals denote the same constituent elements.

In this case, it will be understood that each block of processing flowchart illustrations and combination of flowchart illustrations may be performed by computer program instructions. These computer program instructions may be incorporated into a processor of a general purpose computer, a special purpose computer, or other programmable data processing equipment, such that the instructions executed by the processor of the computer or other programmable data processing equipment create means for performing the functions described in the flowchart block(s). These computer program instructions may also be stored in a computer usable or computer-readable memory that can direct a computer or other programmable data processing equipment to function in a particular manner, such that the instructions stored in the computer usable or computer-readable memory produce an article of manufacture including instruction means that performs the function described in the flowchart block(s). The computer program instructions may also be loaded onto a computer or other programmable data processing equipment to cause a series of operational steps to be performed on the computer or other programmable data processing equipment to produce a computer implemented process such that the instructions that execute on the computer or other programmable data processing equipment may provide steps for implementing the functions described in the flowchart block(s).

In addition, each block may represent a module, segment, or portion of code that includes one or more executable instructions for executing a specified logical function(s). Additionally, it should be noted that it is possible for the functions mentioned in the blocks to occur out of order in some alternative execution examples. For example, two blocks illustrated in succession may in fact be performed substantially simultaneously, or the blocks may sometimes be performed in a reverse order depending on the corresponding function.

In this case, as used herein, the term “unit,” “part,” or “portion” means software or a hardware constituent element, such as a field programmable gate array (FPGA) or an application specific integrated circuit (ASIC), where the term “unit,” “part,” or “portion” performs some role. However, the term “unit,” “part,” or “portion” is not limited to software or hardware. The term “unit,” “part,” or “portion” may be configured to be in an addressable storage medium or configured to reproduce one or more processors. Thus, as an example, the term “unit,” “part,” or “portion” includes constituent elements such as software constituent elements, object-oriented software constituent elements, class constituent elements, and task components, processes, functions, properties, procedures, subroutines, segments of program codes, drivers, firmware, microcode, circuitry, data, database, data structures, tables, arrays, and variables. The functions provided in the constituent elements and the term, “units,” “parts,” or “portions” may be combined into a smaller number of constituent elements, “units,” “parts,” and “portions” and/or divided into additional constituent elements, “units,” “parts,” and “portions.” In addition, the constituent elements and “units,” “parts,” and “portions” may be implemented to execute one or more CPUs within a device or secure multimedia card.

Hereinafter, a base station, as an entity responsible for performing resource allocation of a terminal, may be at least one of a Node B, a BS (base station), an eNB (eNode B), a gNB (gNode B), a radio access unit, a base station controller, or a node on the network. The terminal may include user equipment (UE), a mobile station (MS), a 5G UE, a cellular phone, a smartphone, a computer, or a multimedia system capable of performing communication functions. In addition, the embodiments of the present disclosure described below may be applied to other communication systems with a similar technical background or channel types as those of the present disclosure. In addition, the embodiments of the present disclosure may be applied to other communication systems with some modifications without substantially departing from the scope of the present disclosure as determined by those skilled in the art. For example, this may include 5G wireless communication technologies (5G, new radio, NR) that are developed after LTE-A, and 5G below may be a concept that includes existing LTE, LTE-A, and other similar services. In addition, the present disclosure may be applied to other communication systems with some modifications without substantially departing from the scope of the present disclosure as determined by those skilled in the art.

The terms used to identify connection nodes (node), terms referring to network entities or network functions (NFs), terms referring to messages, terms referring to interfaces between network entities, and terms referring to various identification information in the following description are provided for illustrative purposes for the convenience of description. Therefore, the present disclosure is not limited to the terms described below, and other terms referring to subjects with equivalent technical meanings may be used.

Hereinafter, for the convenience of the description, some terms and names defined in the 3rd generation partnership project (3GPP) long term evolution (LTE) specification and/or the 3GPP new radio (NR) specification may be used. However, the present disclosure is not limited by the terms and names, and may be equally applied to systems following other specifications.

FIG. 1 illustrates a control plane connection structure in a wireless communication system according to an embodiment of the present disclosure.

With reference to FIG. 1, the user equipment (UE) may exchange control messages with a base station using an access stratum (AS) protocol and may exchange control messages with a core network using a non-access stratum (NAS) protocol.

The AS protocol and NAS protocol, which are control plane protocols used by user equipment, are defined and managed by specifications. Therefore, when introducing a new service that includes user equipment into the system or when a change to the protocol is required in relation to a previously introduced service, the relevant content needs to be reflected in the specifications, and a long lead time is required for new chipsets to be manufactured based on the corresponding specifications.

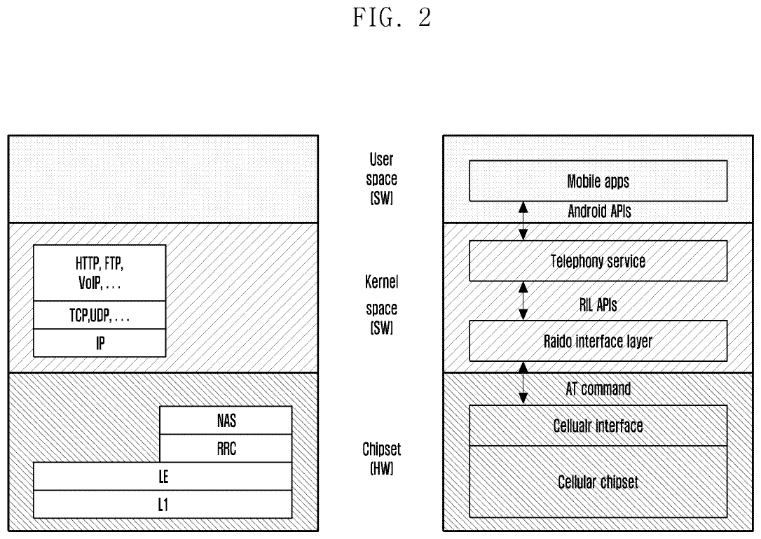

FIG. 2 illustrates a user equipment in a wireless communication system according to an embodiment of the present disclosure.

As described above with reference to FIG. 1, in the existing system, when introducing a new service into the system or when a protocol change is required for a previously introduced service, the chipset within the user equipment needs to be newly manufactured and reflected, resulting in a long lead time. Furthermore, replacing the user equipment was necessary in order to utilize the newly introduced service.

Recent wireless communication systems accommodate not only traditional hand-held-based user equipment but also various types of end-devices with different form factors and capabilities, such as vehicles, robots, and internet of things (IoT) sensors. Accordingly, recent wireless communication systems aim to provide various types of new services through user equipment. However, the conventional design of the NAS protocol and its operation method require a long lead time, making it difficult to introduce new functions into the system. Moreover, since each protocol needs to be defined to possibly support a various kinds of devices, there has been a problem of low efficiency in terms of optimization for different types of devices and services. Previously, due to the limitations of such design and operation methods, the diversification of network services was not actively pursued, and this also acted as a reason for the difficulty in introducing and operating specialized services for specific services or terminals.

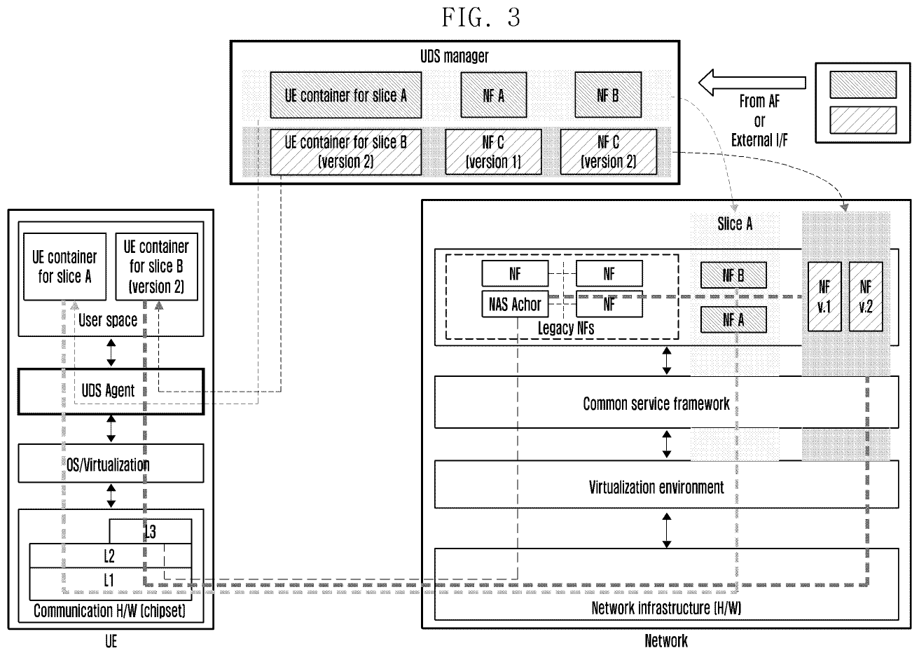

FIG. 3 illustrates a wireless communication system according to an embodiment of the present disclosure.

The present disclosure provides the introduction of a user defined service (UDS) manager, as a new network function (NF), within the core network, and also provides the introduction of a UDS agent, as a new logical device, within the user equipment (UE).

In this specification, the term user defined service (UDS) may refer to a service that is intended to be flexibly and dynamically managed and operated on a communication system.

With reference to FIG. 3, the UDSM may receive and manage UDS-related constituent elements from an external interface or application function (AF), and may perform the deployment, modification, or deletion of network functions (NF) at a network end through operation administration maintenance (OAM).

The UDSM may interact with the UDS agent, a new logical device introduced in the user equipment, and through this interaction with the UDS agent, may perform the deployment, modification, or deletion of a UE container. In this process, the UDSM may deliver configuration information related to the configuration of the user equipment (UE) that need to be performed by the UDS agent to the UDS agent.

The UDSM may operate to configure an appropriate message delivery path on the network side for each UDS.

The UDS agent, through interaction with the UDSM, may perform the deployment and management of the UE container and perform environment configuration on L2, L3, and service access point (SAP) within the UE to suit each UDS. According to the performed environment configuration, the UDS agent may transmit UDS messages via NAS and may allocate a new signaling radio bearer (SRB) and perform routing for IP packet transmission.

The UDS agent may perform updates to the UDS delivery information in situations such as handovers caused by the movement of the user equipment.

According to this embodiment of the present disclosure, services that are outside the specifications may be registered with the UDSM, the service management entity within the system, through the AF or external interface. Among the constituent elements of the registered service, the network-side functions may be deployed by the UDSM, while the UE-side functions may be deployed by the UDS agent. The deployed functions may be utilized to exchange messages with each other according to the configurations of the UDSM and UDS agent and may operate to achieve the purpose of the newly introduced service, accordingly.

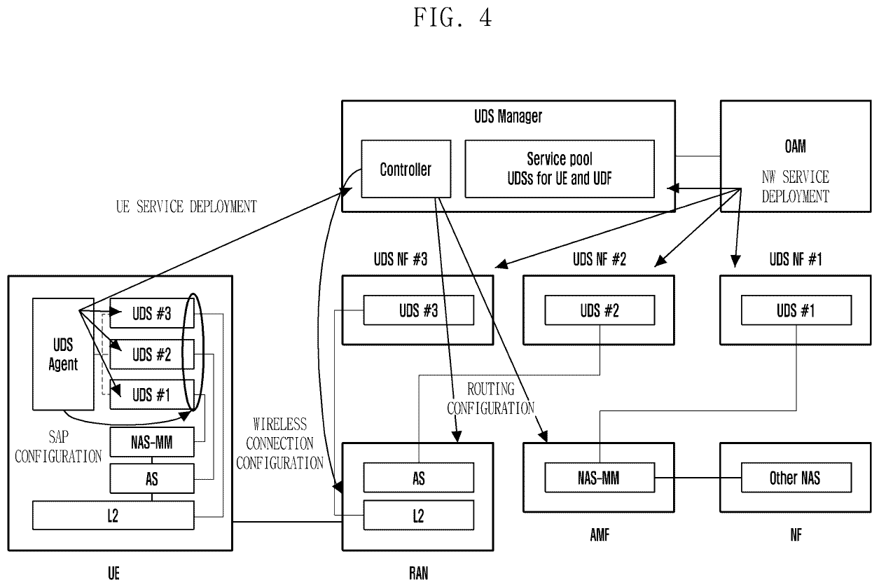

FIG. 4 illustrates a wireless communication system according to an embodiment of the present disclosure.

With reference to FIG. 4, the core network may include the UDSM, and the user equipment (UE) may be configured to include the UDS agent.

According to an embodiment of the present disclosure, the UDS may be configured of one or more UDS NFs (e.g., VNF, CNF, etc.) and one or more UE containers. The UDS NF is the network-side function that configures the UDS, while the UE container is the user equipment-side function that configures the UDS.

The UDSM, as described above, may receive and manage UDS-related constituent elements from an external interface or application function (AF), and may perform the deployment, modification, or deletion of network functions (NF) at a network end through operation administration maintenance (OAM).

The UDSM may interact with the UDS agent, a new logical device introduced in the user equipment, and through this interaction, may perform the deployment, modification, or deletion of a UE container. In this process, the UDSM may deliver configuration information related to the configuration of the user equipment (UE) that need to be performed by the UDS agent to the UDS agent.

The UDSM may configure an appropriate network-side message delivery path and wireless connection information for each UDS.

According to an embodiment of the present disclosure, the UDSM may be configured independently as a separate device within the network. In contrast, the UDSM may be implemented integratively with other network devices. When the UDSM is implemented integratively with other network devices, the functions of the UDSM provided in the present disclosure may be performed by the other network devices.

When the UDSM is implemented integratively with other network devices, the functions of UDSM may be integrated with network devices such as the unified data management (UDM), which comprehensively manages various information within the system, the AMF responsible for an NAS routing function, or the RAN responsible for an AS routing function. The UDSM may also be implemented in integration with other network devices beyond those mentioned.

As described above, the UDS agent is a logical device that manages UDS within the user equipment and is a device newly provided by the present disclosure.

The UDS agent, through interaction with the UDSM, may perform the deployment and management of the UE container and perform environment configuration on L2, L3, and service access point (SAP) within the UE to suit each UDS. According to the performed environment configuration, the UDS agent may transmit UDS messages via NAS and may allocate a new signaling radio bearer (SRB) and perform routing for IP packet transmission.

The UDS agent may perform updates to the UDS delivery information in situations such as handovers caused by the movement of the user equipment.

According to an embodiment of the present disclosure, the software such as the UDS agent or UE container defined in the present disclosure may not only refer to a form that is dynamically installable or removable. For example, for special-purpose user equipment with limited resources, when the functions and parameter configuration appropriate to its purpose are applied to the corresponding user equipment, and the UDSM performs the deployment of the corresponding UDS NF and network configuration, it may be understood as equivalent to the deployment of the UE container and the configuration of the UDS agent being performed as provided by the present disclosure.

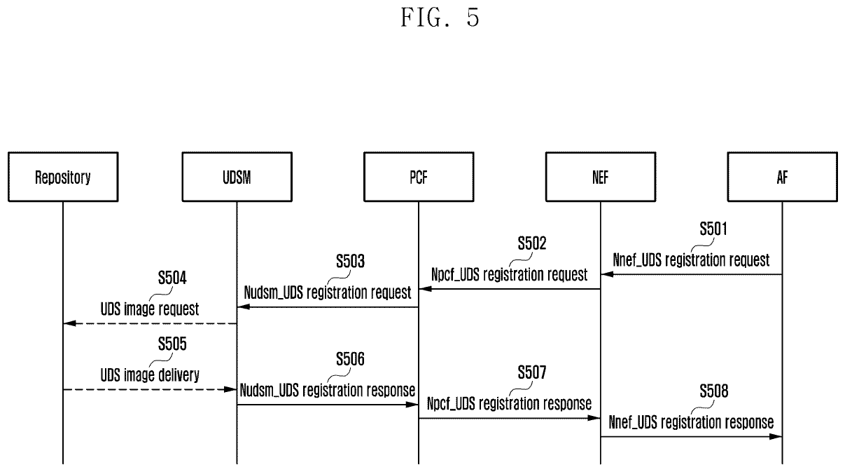

FIG. 5 illustrates a flowchart of a method for performing, a UDS registration procedure according to an embodiment of the present disclosure.

A UDSM 540 receives a request from the AF for the registration of a UDS required by a corresponding application (S501) and may provide the requested UDS. In this case, a UDS registration request message (Nnef_UDS registration request) delivered in step S501 may include one or more NF images and one or more UE containers.

To provide the UDS requested by the AF, each network device may provide services as follows.
The UDSM may provide services such as the UDS registration request, UDS modification request, or UDS deletion request, which can be invoked by the PCF.
The PCF may provide services such as the UDS registration request, UDS modification request, or UDS deletion request, which can be invoked by the NEF or AF. According to an embodiment, when the AF operates within a trusted area, the AF may directly invoke the service of the PCF without routing through the NEF.
The NEF may provide services such as the UDS registration request, UDS modification request, or UDS deletion request, which can be invoked by the AF.

The message for the registration, modification, or deletion request of each UDS may include a UDS ID, UDS version, UDS constituent elements, a service list of the UDS constituent elements, and UDS-related information, and the like.
The UDS constituent element may directly include a UDS image, or alternatively, the UDS image may be stored in a separate repository, with only an address value thereof being included in the UDS constituent element.
The UDS-related information may include service requirements (e.g., low latency, high reliability, etc.), necessary hardware features (e.g., GPU or smart NIC, etc.), operating systems (e.g., Linux, etc.), protocols (e.g., NAS, UDP, etc.), and the like.
The PCF may allow information regarding service operation policies (such as a list of servers where the UDS NF can be positioned, the amount of server resources available to the UDS NF, and a UE class where the UE container can be deployed) to be included in the message of S503 (Nudsm_UDS registration request) and deliver the information to the UDSM, in accordance with the corresponding application-related policies.

According to an embodiment of the present disclosure, the deletion request may not include the UDS constituent element.

In addition to the procedure through the AF described above with reference to FIG. 5, the UDSM may also directly receive the UDS constituent element via an external interface managed by the mobile network operator (MNO). In this case, the registration procedure for the information may follow the methods specified by the system managed by the mobile network operator.

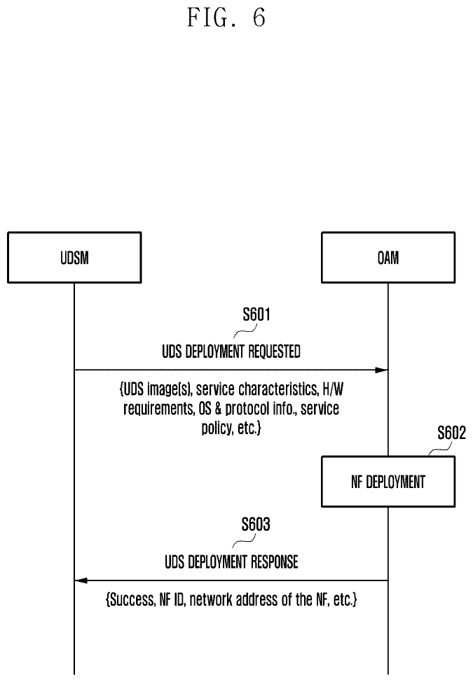

FIG. 6 illustrates a flowchart of a method for deploying, by UDSM, a UDS on a network side according to an embodiment of the present disclosure.

With reference to FIG. 6, the UDSM may deliver the NF image (or the address of a repository storing the NF image) and a description thereof, and may request the operation administration maintenance (OAM) to generate the NF (S601).

The description may include service requirements delivered from the AF and service operation policies delivered from the PCF, and, in addition, may further include information necessary or helpful for the OAM to determine the deployment environment of the corresponding NF.

The OAM may provide a request-response type of service to allow the UDSM to access management functions within the network function management layer through the management service (MnS) interface.

The OAM may perform the deployment of the NF (S602) and may deliver a success response to the UDSM (S603). In step S603, the OAM may deliver an NF identifier (ID) and an NF address together in a response message.

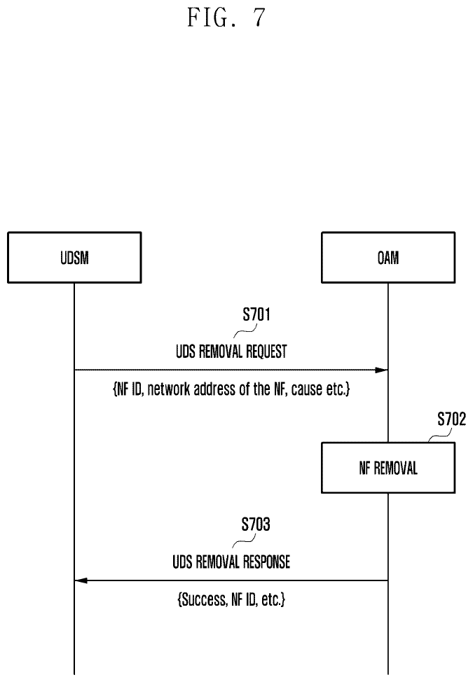

FIG. 7 illustrates a flowchart of a method for removing, by the UDSM, the UDS deployed on a network according to an embodiment of the present disclosure.

With reference to FIG. 7, the UDSM may request the OAM to remove the NF using the NF identifier (ID) and the NF address (S701), and the OAM may receive a message from the UDSM regarding the NF removal request, remove the specified NF accordingly (S702), and transmit a response message regarding the NF removal to the UDSM (S703).

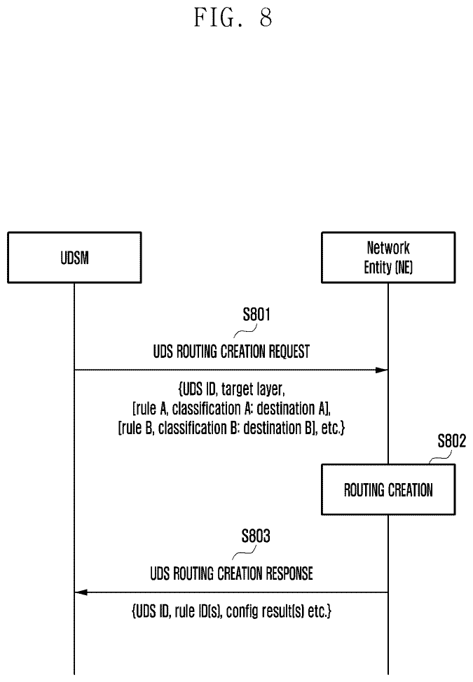

FIG. 8 illustrates a flowchart of a method for configuring, by the UDSM, a message delivery path for each UDS within the network according to an embodiment of the present disclosure.

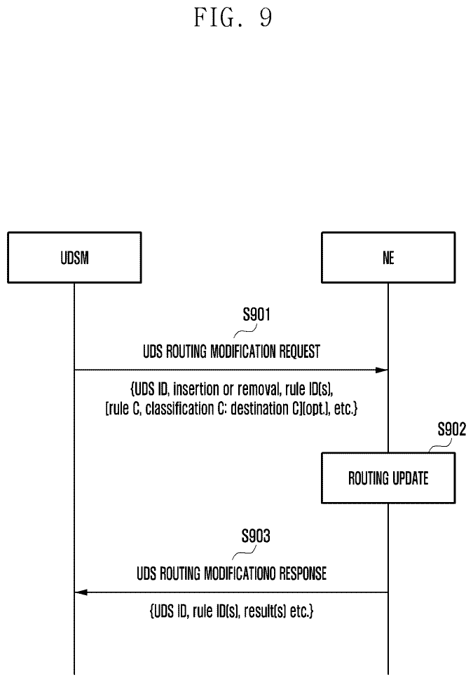

FIG. 9 illustrates a flowchart of a method for modifying, by the UDSM, the message delivery path configured for each UDS according to an embodiment of the present disclosure.

With reference to FIG. 8, the UDSM may determine the appropriate routing layer by referring to the protocol and routing requirements used by each UDS.

According to an embodiment of the present disclosure, the UDS may use one of the protocols such as NAS, TCP, UDP, or QUIC, and the routing requirements may include specific field values in the UDS packet header for destination distinction.

According to an embodiment of the present disclosure, when the UDS uses the NAS protocol, the UDSM may allocate a unique extended protocol discriminator (EPD) for the corresponding service, and deliver the address of the UDS NF mapped to the EPD together to the network entity including the routing layer.

The UDSM may request each network entity that includes the routing layer to configure routing environment for the corresponding layer.

According to an embodiment of the present disclosure, when the UDS does not use the NAS protocol, the allocation of a new signaling radio bearer (SRB) for IP packets in the network-side AS layer may be requested, and IP routing may be applied to the packets delivered through the corresponding SRB thereafter. The UDSM may transmit the corresponding UDS NF address along with the request for a new SRB.

To configure the message delivery path for each UDS, the network entity (NE) where the NAS anchor is located and the RAN entity may provide services to the UDSM for the creation, modification, or removal of routing.
A routing creation request (S801) may include a UDS ID, a target layer, a rule ID, message identification criteria, a destination address, and the like.
A routing modification request (S901) may include a rule ID to be added or removed, additional information (e.g., message identification criteria, destination address), and the like.
A routing removal request (not illustrated) may be used for the complete deletion of routing configurations using the UDS ID.

The network entity (NE) or RAN entity may receive a request from the UDSM for routing creation, modification, or removal, and accordingly perform routing creation (S802), routing update (S902), or routing removal (not illustrated), and then may deliver a response for routing creation (S803), routing modification (S903), or routing removal (not illustrated) to the UDSM.

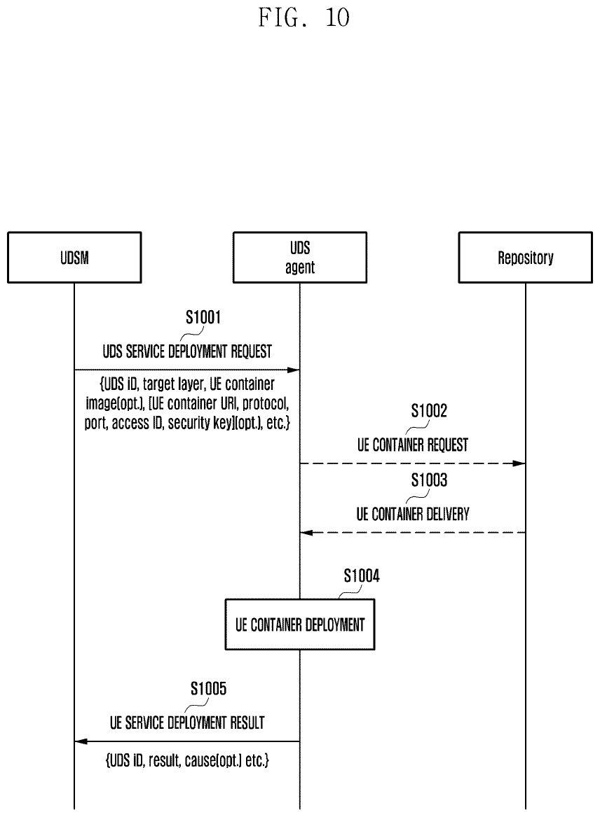

FIG. 10 illustrates a flowchart of a method for deploying a UE container according to an embodiment of the present disclosure.

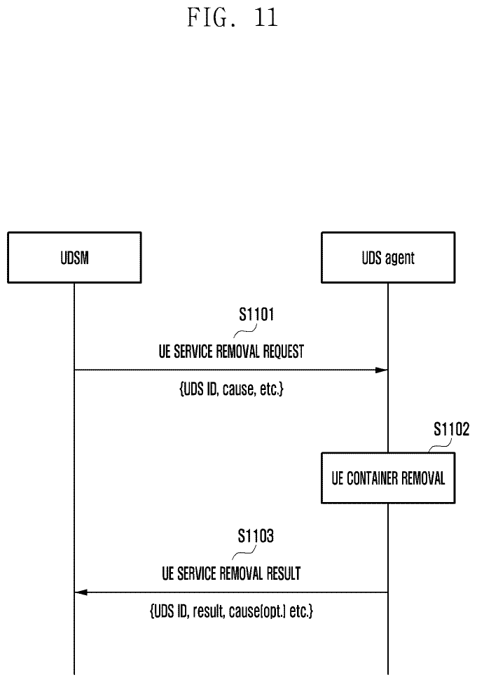

FIG. 11 illustrates a flowchart of a method for removing a UE container according to an embodiment of the present disclosure.

The UDSM may use the NAS protocol to request the UDS agent to deploy (S1001) or remove (S1101) the UE container.

When making a deployment request for a UE container (S1001), the UDSM may deliver the UDS ID along with information on the previously determined routing layer to the UDS agent. According to an embodiment of the present disclosure, when the UDS uses a protocol other than the NAS protocol, the UDSM may deliver the UDS ID along with information on the SRB to be used (e.g., SRB index) to the UDS agent.

When making a deployment request for a UE container (S1001), the UDSM may either directly deliver the image of the UE container or deliver the address of a separate repository where the UE container image is stored, allowing the UDS agent to download the UE container image directly from the corresponding address.

When the UDSM directly delivers the UE container image, the UDSM may transmit the metadata, such as a file name, version, and size, separately from a bit string corresponding to file content. In contrast, when the UDSM does not directly deliver the UE container image but uses a repository, the UDSM may deliver the UE container image along with protocol information (e.g., HTTP, FTP, etc.), a port, the address of the corresponding image, access information (account information, security key, etc.), and the like to the UDS agent.

When requesting the removal of the UE container (S1101), the UDSM may use the UDS ID.

After receiving the deployment request (S1001) or removal request (S1101) of the UE container from the UDSM, the UDS agent may perform the deployment (S1004) or removal (S1102) of the UE container and deliver the result of the performance to the UDSM (S1005 or S1103).

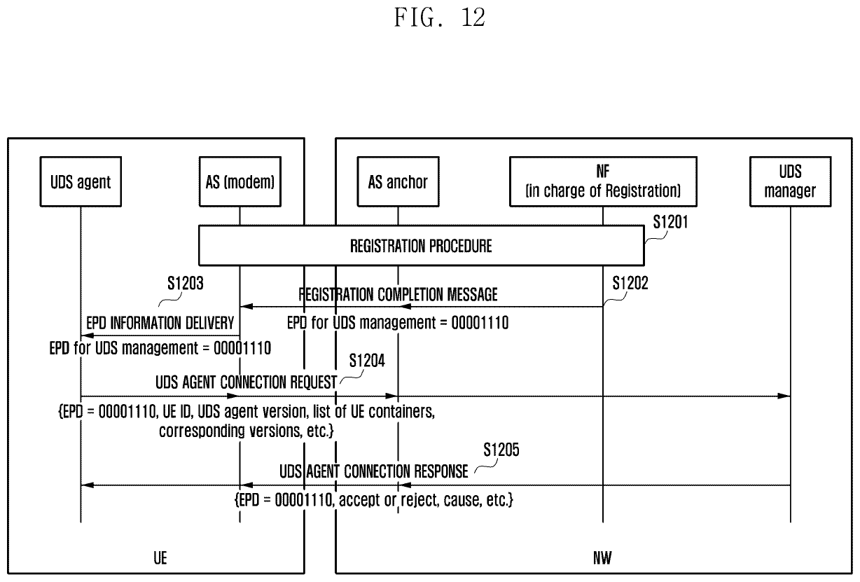

FIG. 12 illustrates a flowchart of a method for a connection procedure between a UDS agent and UDSM according to an embodiment of the present disclosure.

According to an embodiment of the present disclosure, the connection between the UDS agent and the UDSM may be performed through the NAS protocol.

The UDS agent may receive the NAS-related information to be used for the connection to the UDSM through the registration completion message (S1202). According to an embodiment, the AS (modem) within the user equipment (UE) may receive the registration completion message (S1202) through the AS anchor on the network and then deliver the EPD information to the UDS agent within the user equipment (S1203).

The UDS agent may transmit a connection request message to the UDSM using the received EPD information (S1204). The connection request message may include information such as the UE ID, the version of the UDS agent, and the list and versions of the operating UE containers.

After receiving the connection request message from the UDS agent (S1204), the UDSM may deliver a response message regarding the request to the UDS agent through the AS anchor and the modem of the user equipment (S1205).

According to an embodiment of the present disclosure, when an update to a higher version of the UE container is required after the operation in FIG. 12, the UDSM may perform the update of the UE container through the deletion and deployment request of the UE container.

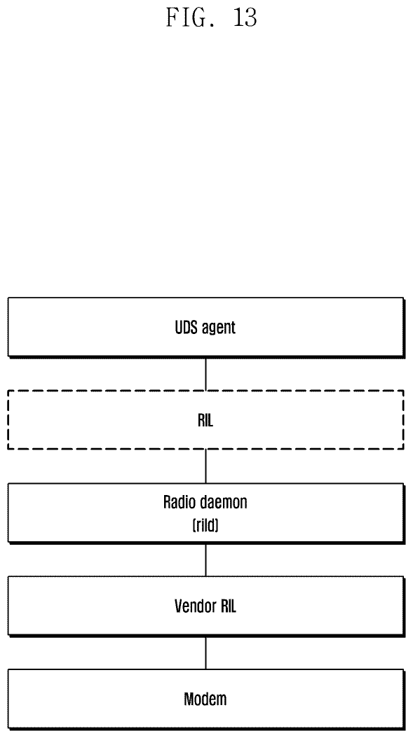

FIG. 13 illustrates a connection structure of logical devices within user equipment according to an embodiment of the present disclosure.

With reference to FIG. 13, the modem of the user equipment may configure and provide an interface (radio interface layer (RIL)), to exchange information with the UDS agent.

A vendor RIL is a layer that provides communication functions for exchanging information with software or hardware responsible for specific wireless connections, such as the wireless communication modem and chipset within the user equipment. A radio interface layer (RIL) daemon (rild) may dynamically load the vendor RIL to control the device and provide functions such as receiving responses from the device.

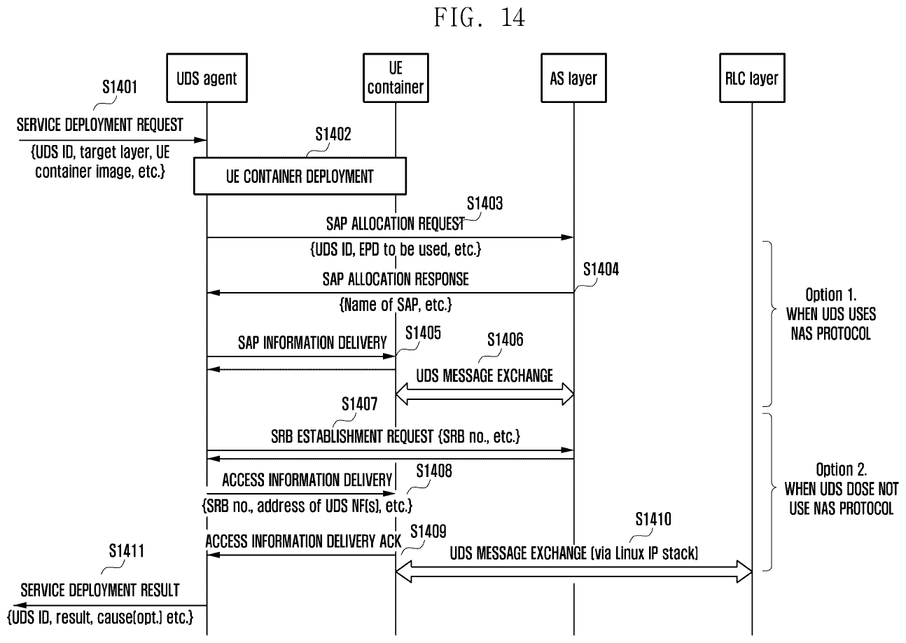

FIG. 14 illustrates a flowchart of a method for deploying, by a UDS agent, a UE container and performs initial configuration according to an embodiment of the present disclosure.

The UDS agent may receive the image of the UE container through a NAS message from the UDSM and install the image within the storage space of the user equipment. According to an embodiment of the present disclosure, when the NASM uses a repository, the NASM provides information on the repository where the UE container image is stored to the UDS agent. The UDS agent may then use the access information of the repository to receive and install the UE container image from the repository. The UDS agent may have the authority to configure the environment necessary for the UE container to operate within the terminal (e.g., configuring and managing a virtualization environment), in order to install the image of the UE container within the user equipment.

In installing the UE container, the UDS agent may configure the message delivery path for the UE container according to the protocol information received from the UDSM.

According to an embodiment of the present disclosure, when the UDS uses the NAS protocol, the UDS agent may perform an allocation request for the SAP for the corresponding UDS to the AS layer within the terminal (S1403) and may receive a response thereto (S1404).

According to another embodiment of the present disclosure, when the UDS does not use the NAS protocol, the UDS agent may configure the SRB to be used through the IP stack of a kernel according to the SRB information and RLC channel information delivered from the UDSM (S1407).

The UDS agent may perform the deployment of the UE container and transmit the result thereto to the UDSM (S1411).

When the UDSM requests the deletion of the UE container, the UDS agent may delete the corresponding UE container using the UDS ID and deliver the result to the UDSM.

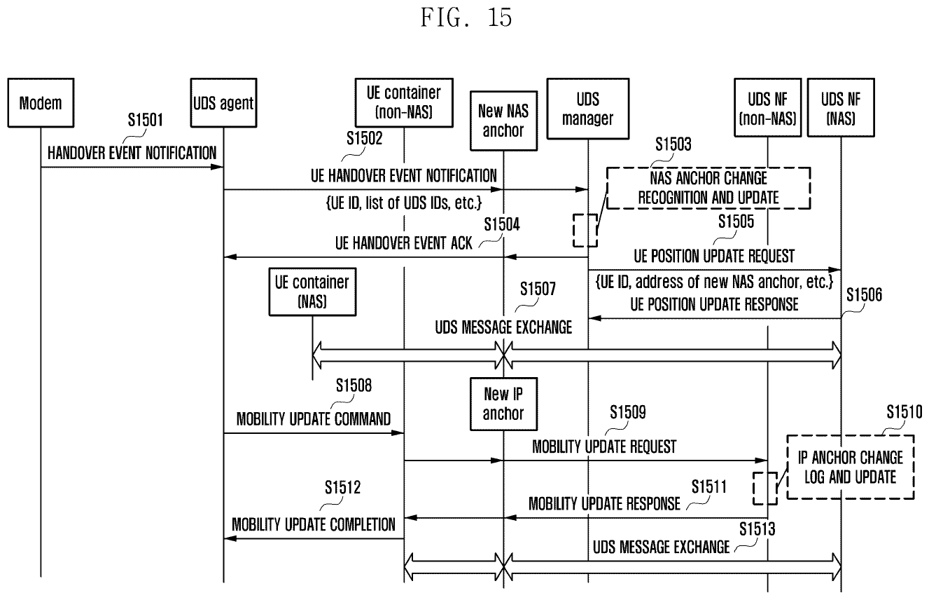

FIG. 15 illustrates a flowchart of a method for updating UDS delivery information according to an embodiment of the present disclosure.

As the user equipment has mobility, a handover to the base station may be performed on the user equipment. The UDS agent may receive a notification for the handover event from the modem of the user equipment and respond to potential changes in the NAS anchor or IP anchor that may occur during the handover.

The UDS agent may receive a handover event notification from the modem of the user equipment (S1501). When a handover occurs that involves a change in the network entity (e.g., inter-gNB handover, etc.), the modem may notify the UDS agent of the occurrence of the corresponding event.

The UDSM may receive an update message regarding the handover from the UDS agent (S1502), determine a change of the NAS anchor on the basis of a final origin, and perform the update accordingly (S1503). For example, the UDSM may determine that the NAS anchor has changed when data for a specific user equipment, initially received through a first NAS anchor, is later received through a second NAS anchor.

The UDSM, after determining a change in the NAS anchor, may transmit an update message regarding the position of the user equipment to UDS NFs that use the NAS protocol (S1505).

When the UDS does not use the NAS protocol, the UDS agent may transmit mobility-related update commands to the UE containers of UDS that do not use the NAS protocol when a handover event occurs (S1508). The UDS NFs that do not use the NAS protocol may receive a mobility-related update request message of the user equipment from the UE container that does not use NAS (S1509), determine a change of the IP anchor on the basis of the final origin of the message, and perform the update (S1510). Subsequently, a response to the mobility update request may be transmitted to the UE container that does not use NAS (S1511).

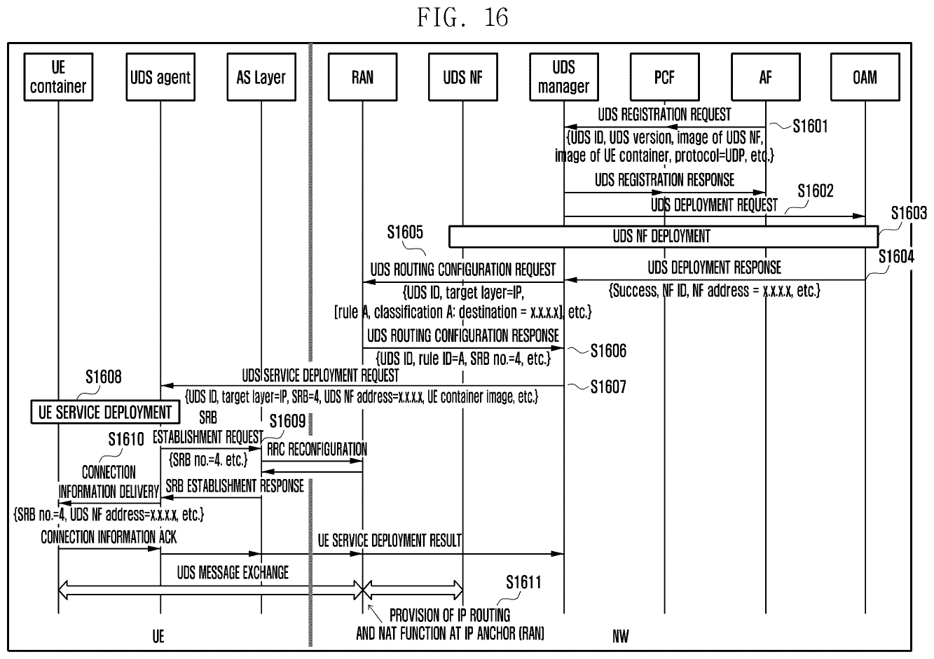

FIG. 16 illustrates a flowchart of a method for a procedure of UDS deployment and message exchange according to an embodiment of the present disclosure.

In FIG. 16, UDP is used as a transmission protocol, and the deployment and message exchange of the UDS are performed on a network configured of one UDS NF and one UE container.

The AF may perform a UDS registration request to the UDSM through the PCF (S1601) and may receive a response thereto. The UDS registration request message transmitted by the AF may include the UDS ID, UDS version, UDS NF image, UE container image, and information indicating the use of the UDP protocol, and the like. The PCF, upon receiving the UDS registration request from the AF, may deliver the UDS registration request to the UDSM with the addition of information regarding the necessary service operation policies.

The UDSM may deliver the image of the UDS NF among the registered UDS constituent elements to the OAM and request the deployment of the UDS NF within the network (S1602). The OAM may perform the deployment of the UDS NF in accordance with such a request (S1603).

After performing the deployment of the UDS NF in the network, the OAM may deliver a response regarding the success of the deployment to the UDSM (S1604). The response regarding the success of the deployment may include a NF ID and the network address of the NF.

The UDSM may request the RAN node to configure a transmission path in order to configure a network-side transmission environment of the UDS that uses the UDP (S1605). The transmission path configuration request from the UDSM may include information indicating that a layer where routing may be performed is the IP layer. Since the UDS does not use the NAS protocol, it is not mandatory for the routing configuration request to include the address of the UDS NF. However, according to an embodiment, the UDSM may allow the address of the NF to be included in the routing configuration request and transmitted.

Since FIG. 16 pertains to the case where the UDS uses IP routing, the RAN node may allocate a new SRB for the exchange of control messages configured of IP packets, deliver the information thereon to the UDSM, and perform a response regarding the routing configuration (S1606). With reference to the embodiment of FIG. 16, the UDSM may request routing configuration by including A as a rule ID, and the RAN node may respond to this request by allocating SRB 4.

The UDSM may request the UDS agent to perform the deployment of the UE container (S1607), and the UDS agent may accordingly perform the deployment of the UE container (S1608). With reference to the embodiment of FIG. 16, the UDSM may deliver the information that a message may be transmitted to the UDS NF with a specific address through IP routing using SRB 4.

The UDS agent, on the basis of the information delivered from the UDSM, may request the AS layer within the user equipment to establish the connection between the network and the corresponding SRB (S1609) and may receive a response thereto. The AS layer may perform the configuration of the radio resource control (RRC) through interaction with the RAN side of the network.

The UDS agent may deliver connection information to the UE container (S1610). The connection information being delivered may include the SRB information and the UDS NF address. Subsequently, the UDS agent may deliver the result of the UE container deployment to the UDSM.

According to an embodiment of the present disclosure, during the process of control message exchange being performed using the UDP/IP protocol between the UE container and the UDS NF, a node of performing a role of the IP anchor may perform IP routing and, simultaneously provide a network address translation (NAT) function (S1611) to ensure that the user equipment with mobility within the system may communicate with network devices without issues.

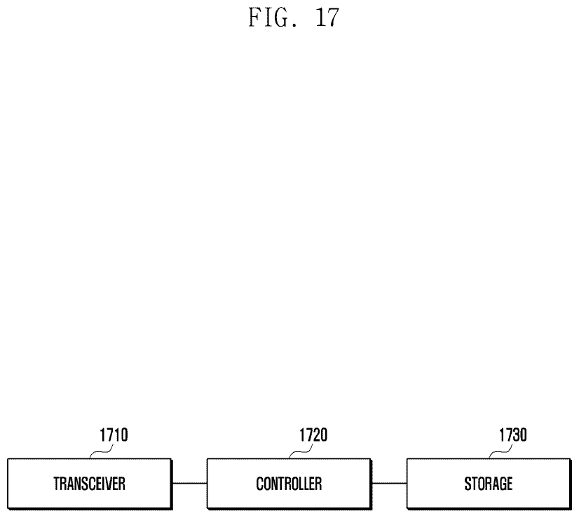

FIG. 17 illustrates a structure of a terminal according to an embodiment of the present disclosure.

With reference to FIG. 17, the terminal may include a transceiver 1710, a controller 1720, and storage 1730. In the present disclosure, the controller may be defined as a circuit, an application specific integrated circuit (ASIC), or at least one processor.

The transceiver 1710 may transmit and receive signals to and from other network entities. For example, the transceiver 1710 may receive system information from the base station and may receive a synchronization signal or a reference signal.

The controller 1720 may control overall operation of the terminal as provided in the present disclosure. For example, the controller 1720 may control the overall functions of the terminal according to the embodiment provided in the present disclosure. For example, the controller 1720 may control the terminal or UE to perform the deployment or deletion of the UE container.

The storage 1730 may store at least one of information transmitted and received through the transceiver 1710 or information generated through the controller 1720. For example, the storage 1730 may store information on the UE container, information related to the EPD, and the like.

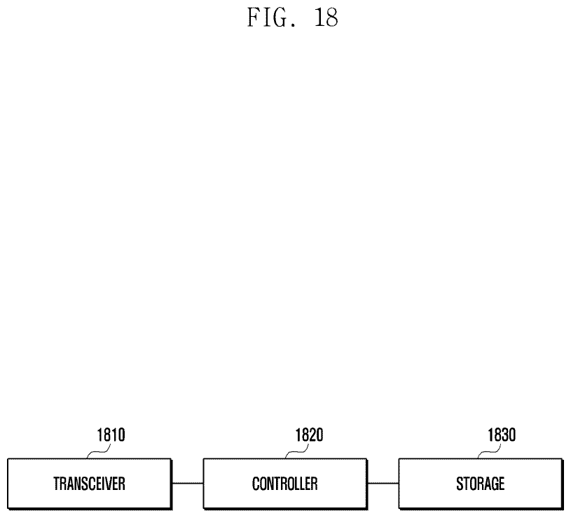

FIG. 18 illustrates a structure of a network entity according to an embodiment of the present disclosure. The network entity may be configured of the AMF, UPF, UDSM, SMF, PCF, UDR, UDM, NEF, AF, or the like.

The transceiver 1810 may transmit and receive signals to and from other network entities The transceiver 1810 may, for example, transmit information related to UDS service deployment to the terminal.

The controller 1820 may control the overall operations of the network entities according to the embodiment provided in the present disclosure. For example, the controller 1820 may operate to control the operations according to the flowchart described above. As an example, the controller 1820 may control the UDSM to receive a UDS registration request from the AF, deliver the image of the UDS NF to the OAM, and deliver the image on the UE container to the UE agent.

The storage 1830 may store at least one of information transmitted and received through the transceiver 1810 or information generated through the controller 1820. For example, the storage 1830 may store the UDS ID, UDS version, information on the UDS NF, and information on the UE container.

It should be noted that the configurations, examples of control/data signal transmission methods, examples of operation procedures, and constituent elements illustrated in FIGS. 1 to 18 are not intended to limit the scope of rights of the present disclosure. That is, it should not be construed that all constituent elements described in FIGS. 1 to 18, entities, or operations are essential constituent elements to embody the disclosure, but only parts of the constituent elements may be implemented to embody the disclosure within a range that does not hamper the essence of the disclosure.

The operations of the network entity or the terminal as described above may be implemented by providing a memory device in which the corresponding program codes are stored in a certain constituent element of the network entity or the terminal device. That is, in order to execute the above-described operations, the controller of the network entity or the terminal device may read and execute the program codes stored in the memory device through a processor or a central processing unit (CPU).

Various constituent elements of the network entity, the base station, the terminal device, or modules as described above in the description may operate using hardware circuits, for example, complementary metal oxide semiconductor based logic circuits, firmware, software, and/or hardware and firmware, and/or combinations of software inserted into a machine readable medium. As an example, various electrical structures and methods may be embodied using transistors, logic gates, and electrical circuits such as application specific integrated circuits.

While the detailed description of the present disclosure has described specific embodiments, it will be apparent that various modifications may be made without departing from the scope of the present disclosure. Therefore, the scope of the present disclosure should not be limited to the described embodiments, but should be defined by not only the claims to be described below and equivalents to the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first network entity for operating a user defined service (UDS) in a wireless communication system, the method comprising:
receiving, from an application function (AF), a UDS registration procedure request message including UDS network function (NF) information and UE container information;
transmitting, to operation administration maintenance (OAM), a request message for UDS deployment, the request message including the UDS NF information; and
transmitting, to a UDS agent in user equipment (UE), a UE container deployment request message including the UE container information.

2. The method of claim 1, further comprising:
transmitting, to a second network entity, a routing configuration request message for the UDS deployment.

3. The method of claim 2, further comprising:
allocating an extended protocol discriminator (EPD) for the UDS when a protocol used by the UDS is a non-access stratum (NAS),
wherein the routing configuration request message includes address information on the UDS NF mapped to the EPD.

4. The method of claim 2, wherein when a protocol used by the UDS is not a NAS, the routing configuration request message includes a signaling radio bearer (SRB) allocation request for internet protocol (IP) packets.

5. The method of claim 1, further comprising:
receiving, from the UDS agent, handover event-related information for the UE;
determining, based on NAS anchor information, a change of a NAS anchor that delivers the handover event-related information; and
transmitting, to the UDS NF, information for the change of the NAS anchor when the NAS anchor has changed.

6. A method performed by a user defined service (UDS) agent included in a user equipment (UE) in a wireless communication system, the method comprising:
receiving, from a first network entity, a UE container deployment request message including UE container information related to the UDS;
installing a UE container into the UE; and
configuring, based on the UE container information, a message delivery path for the UE container.

7. The method of claim 6, further comprising:
receiving, from an access and mobility management function (AMF), an extended protocol discriminator (EPD); and
transmitting, to the first network entity, a connection request message including the EPD.

8. The method of claim 6, further comprising:
requesting an access stratum (AS) layer in the UE to configure a service access point (SAP) corresponding to the UDS when a protocol used by the UDS is a non-access stratum (NAS).

9. The method of claim 6, further comprising:
requesting an access stratum (AS) layer in the UE to configure a signaling radio bearer (SRB) on SRB information received from the first network entity when a protocol used by the UDS is not a non-access stratum (NAS).

10. The method of claim 6, further comprising:
receiving, from a modem of the UE, handover event-related information; and
transmitting the handover event-related information to the first network entity.

11. A first network entity for operating a user defined service (UDS) in a wireless communication system, the first network entity comprising:
a transceiver; and
a controller operably coupled to the transceiver, the controller configured to:
receive, from an application function (AF), a UDS registration procedure request message including UDS network function (NF) information and UE container information;
transmit, to operation administration maintenance (OAM), a request message for UDS deployment, the request message including the UDS NF information; and
transmit, to a UDS agent in user equipment (UE), a UE container deployment request message including the UE container information.

12. The first network entity of claim 11, wherein the controller is further configured to transmit, to a second network entity, a routing configuration request message for the UDS deployment.

13. The first network entity of claim 12, wherein the controller is further configured to allocate an extended protocol discriminator (EPD) for the UDS when a protocol used by the UDS is a non-access stratum (NAS), and wherein the routing configuration request message includes address information on the UDS NF mapped to the EPD.

14. The first network entity of claim 12, wherein when a protocol used by the UDS is not a NAS, the routing configuration request message includes a signaling radio bearer (SRB) allocation request for internet protocol (IP) packets.

15. The first network entity of claim 11, wherein the controller is further configured to:
receive, from the UDS agent, handover event-related information for the UE;
determine, based on NAS anchor information, a change of a NAS anchor that delivers the handover event-related information; and
transmit, to the UDS NF, information for the change of the NAS anchor when the NAS anchor has changed.

16. A UDS agent included in a user equipment (UE) in a wireless communication system, the UDS agent comprising:
a transceiver; and
a controller operably coupled to the transceiver, the controller configured to:
receive, from a first network entity, a UE container deployment request message including UE container information related to a UDS;
install a UE container into the UE; and
configure, based on the UE container information, a message delivery path for the UE container.

17. The UDS agent of claim 16, wherein the controller is further configured to:
receive, from an access and mobility management function (AMF), an extended protocol discriminator (EPD); and
transmit, to the first network entity, a connection request message including the EPD to.

18. The UDS agent of claim 16, wherein the controller is further configured to:
request an access stratum (AS) layer in the UE to configure a service access point (SAP) corresponding to the UDS when a protocol used by the UDS is a non-access stratum (NAS).

19. The UDS agent of claim 16, wherein the controller is further configured to request an access stratum (AS) layer in the UE to configure a signaling radio bearer (SRB) on SRB information received from the first network entity when a protocol used by the UDS is not a non-access stratum (NAS).

20. The UDS agent of claim 16, wherein the controller is further configured to:
receive, from a modem of the UE, handover event-related information; and
transmit the handover event-related information to the first network entity.
